(19) United States
(12) Patent Application Publication
(10) Pub. No.: US 2014/0079881 A1
(43) Pub. Date: Mar. 20, 2014

(54) CORROSION RESISTANT COMPOSITIONS FOR TITANIUM BRAZING AND COATING APPLICATIONS AND METHODS OF APPLICATION

(71) Applicant: Pessach Seidel, Motza Illit (IL)

(72) Inventors: Olga Botstein, Haifa (IL); Joseph Riskin, Haifa (IL); Pessach Seidel, Motza Illit (IL)

(73) Assignee: Pessach Seidel, Motza Illit (IL)

(21) Appl. No.: 14/032,210

(22) Filed: Sep. 20, 2013

Related U.S. Application Data
(60) Provisional application No. 61/703,308, filed on Sep. 20, 2012.

(51) Int. Cl. B05D 5/00

(52) U.S. Cl. CPC B05D 5/00
USPC 427/205; 420/417; 75/255

(57) ABSTRACT

A composition comprising titanium, a small amount of at least one platinum group metal and alloying elements for lowering melting point of the composition to below titanium beta transus temperature.

### CROSS REFERENCE TO RELATED APPLICATIONS

Benefit is claimed to U.S. Provisional Patent Application No. 61/703,308, filed Sep. 20, 2012, the contents of which are incorporated by reference herein in their entirety.

### BACKGROUND OF THE INVENTION

The present invention relates to joining and surface engineering of titanium and its alloys, and to brazed products, in particular to titanium based equipment, such as plate and other heat exchangers.

Traditional plate heat exchangers are constructed from a plurality of corrugated plates which are assembled as a pack and pressed together using two massive carbon steel plates mounted on each side of the pack and connected thereto by massive coupling bolts or studs. The carbon steel plates may include a fixed plate and a pressure plate, such that tightening the bolts presses the plates against the corrugated plates. The heat exchange between two fluids at different temperatures takes place by their flowing through the passages formed between adjacent corrugated plates. Sealing the space formed between the corrugated plate and distribution of the fluid flow through the passages is executed with the help of rubber gaskets having a complicated shape that are placed between the corrugated plates, along their perimeter. This type of plate heat exchanger is useful for various applications such as chemical processing, sewage treatment, pasteurization of food stuffs and the like.

Traditional plate heat exchangers as described hereinabove are susceptible to corrosion at the points of contact between adjacent corrugated plates due to one or more, and typically all three of the following significant phenomena:

1—The high mechanical stresses exerted by adjacent corrugated plates to each other at the points of contact reduce the corrosion stability of the metal.

2—Vibration of the corrugated plates due to intensive fluid flow through the passages between adjacent corrugated plates, inside which variations of flow direction occur in accordance with the variations in the corrugations. Owing to these vibrations the pressure in the points of contact of adjacent corrugated plate may vary from zero to significant values that leads to fretting corrosion development in these points of contact.

3—Crevice corrosion may develop in the points of contact between adjacent corrugated plates.

The development of crevice corrosion under the rubber gaskets is also rather typical for plate heat exchangers of this type.

The rubber gaskets themselves are unsuitable in harsh environments, and are susceptible to chemical attack. They may leak at high pressures and the rubber degrades at high temperatures.

The above phenomena make traditional plate heat exchangers very susceptible to corrosion attack in aggressive environments.

A fairly corrosion resistant material that is sometimes used for heat exchangers in demanding applications is titanium. There is a need for improved construction methods for fabricating titanium plate heat exchangers.

Joining by brazing is an assembly method that has various advantages that overcome the technical problems associated with other joining techniques. One promising brazing application for titanium is the fabrication of plate heat exchangers (PHE) from titanium.

Replacing the construction of the prior art plate heat exchanger described above by a vacuum brazed construction is expected to mitigate the above mentioned disadvantages. Brazing in the points of contact and along the perimeter of the corrugated plate makes the structure very strong and rigid without requiring the pressing the corrugated plates together by massive end plates. Gaskets between adjacent plates are no longer needed; the “weak spots” in the point of contact between adjacent corrugated plates are eliminated and the danger of crevice corrosion development under rubber gaskets is removed.

Brazing requires use of an appropriate filler material. Brazing of titanium is limited by the chemical and metallurgical properties of titanium since known filler materials tend to interact with and attack the base metal, forming brittle intermetallic compounds.

Depending on the predominant phase or phases in their microstructure, titanium alloys are categorized as alpha (α), alpha-beta (α-β), and beta (β). This natural grouping not only reflects basic titanium production metallurgy, but it also indicates general properties peculiar to each type. The alpha phase in pure titanium is characterized by a hexagonal close-packed crystalline structure that remains stable from room temperature to approximately 882° C. The beta phase in pure titanium has a body-centered cubic structure, and is stable from approximately 882° C. to the melting point of about 1671° C. (at atmospheric pressure).

Adding alloying elements to titanium provides a wide range of physical and mechanical properties. Some alloying additions tend to stabilize the alpha phase; that is, they raise the temperature at which the alloy will be transformed completely to the beta phase. This temperature is known as the beta-transus temperature.

Titanium may be used in corrosive environments. It has been found that the major requirements for brazing Ti and its alloys are as follows:
The brazing temperature must be lower than the beta-transus, i.e. the temperature of α→β phase transition which is about 900° C.;
A high mechanical strength of the joints is required;
High corrosion resistance, without the tendency of forming galvanic couples in which the brazing is anodic (has more negative potential) with respect to the base metal. The brazed joint must be at least as corrosion resistant as the base metal.

In the past, the majority of vacuum titanium brazing has been carried out using silver-based and aluminum-based filler metals. The main disadvantage of the resulting brazed joints is that the service temperature is limited to about 300° C. Furthermore, the formation of brittle intermetallic compounds between the Ti alloy and the brazing filler metal has been found to result in relatively brittle joints and to create problems of galvanic corrosion.

A first attempt to overcome the disadvantages described hereinabove, was to create a Ti-based filler metal, having a brazing temperature that is lower than the -transus of about 900° C. for pure titanium, where the phase transformation occurs in the base metal used for corrugated plates; the corresponding transformation for Ti-6Al-4V alloy is 980° C. It was found that brazing above the Ti β-transus leads to the nucleation and growth of the beta phase, and to a general deterioration of the microstructure with a resultant loss of ductility in the base metal.

The use of rapidly solidified amorphous titanium-zirconium-based (25Ti-25Zr-50Cu) brazing foil, having narrow T_{S}-T_{L} temperature range and a liquidus lower than α→β phase transition temperatures in corrugated plate Ti was a further attempt to cope with the disadvantages of conventional clad strip Ti-15Cu-15Ni. However, in spite of its good wettability, clad strip melts in three separate stages and forms a coarse microstructure with a marked porosity upon crystallization, and a brazing temperature above the β-transus [see A. Rabinkin, M. Lieberman, S. Pounds, T. Taylor, F. Reidinger and S. C. Lui, Scr. Metall., 25, 1991, pp 399-404].

Furthermore, it will be noted that strip material Ti—Zr—Cu cannot be manufactured as homogeneous foil by conventional rolling because of high brittleness resulting from inter-metallic phases forming upon crystallization.

The microstructure of joints formed by brazing and phase transformations responsible, were analyzed using similar amorphous filler metal foils brazed under conditions close to those used in industrial vacuum furnace brazing and induction heating [O. Botstein, A. Rabinkin, Mater. Sci. Eng., A188, 1994, p.p. 305-315., and O. Botstein, A. Schwarzman and A. Rabinkin, Mater. Sci. Eng., A206, 1995, p.p. 14-23]. The use of 25Ti-25Zr-50Cu amorphous filler metal permits brazing of titanium corrugated plates at a temperature lower than that of the α→β transformation and Ti-6Al-4V alloy at a temperature below the -transus, thus preserving the original microstructure of the base metals. The best mechanical properties of the base metal were obtained when brazing under conditions such that the joints have a fine lamellar or cellular αTi+γ(TiZr)₂Cu eutectoid microstructure throughout the braze.

The use of expensive RS (Rapidly Solidified) Ti-based filler metals in the form of foils is technologically and commercially limited for constructions having multiple braze joints, such as plates of a Plate Heat Exchanger, for example. In such applications, the use of cost-effective TiZr based powder alloys would appear to be more attractive.

A Ti-24Zr-16Cu-16Ni powder blend of IVAC showed a significantly lower melting range (860-890° C.) than TiCuNi-60 (920-990° C.) and TiCuNi-70 (930-1050° C.) conventional mechanically alloyed filler metals as provided by Wesgo Metals [A. E. Shapiro AWS-2001, Abstract No. BSM-01102]. However, TiCuNi-60 and TiCuNi-70 are unacceptable for thin-wall brazed articles such as titanium plate heat exchangers, since the microstructure of the base metal (Ti-6Al-4V) brazed by TiCuNi-70 showed significant embrittlement.

A powder blend having a melting temperature in the desired range may be suitable as a braze filler for brazing titanium corrugated heat exchanger plates. The filler powders of the desired composition in the Ti—Zr—Cu—Ni system may be fabricated in various ways, such as by pre-alloying and vacuum atomizing, or by mechanical blending, for example.

U.S. Pat. No. 6,149,051 to Vollmer, et al. (2000) describes the use of Ti-20Cu-20Ni-20Zr powder mixture in the brazing of β-Ti alloy, and claims the brazing temperature, cooling/heating rate and other parameters, but does not mention the method of powder placement. When brazing corrugated plates fabricated from Ti Grade 2 as defined in ASTM B265), the 13-transformed phase was observed in the microstructure, which indicates a deterioration of the base metal.

In O. Botstein, A. Shwartzman, A. Mats, J Danan 2nd International Brazing and Soldering Conference, San Diego, Calif., Feb. 17-19, 2003, the successful use of a Ti-24Zr-16Cu-16Ni powder blend for brazing a plate-fins heat exchanger (PFHE) for aircraft applications was reported. According to the paper, the joints thus fabricated exhibited sufficient fatigue resistance for this purpose. Furthermore, the optimization of the brazing process parameters allowed the achieving of a shear strength that exceeded more than 300 MPa, and was close to the theoretical shear strength of the base metal Ti used for the corrugated plate fins. The filler metal was uniformly placed on the plate by a cold spray technique using an appropriate commercially available organic binder (650 Nircobraz Cement, Wall Colmonoy) and examination of the microstructures confirmed that oxidation and formation of porosity were avoided.

The best results reported in the literature were achieved when a Ti—Zr—Cu—Ni based vacuum atomized pre-alloyed powder is used as filler which is applied to the plate as a thin layer with an organic binder by a cold spray technique before the brazing operation. The results obtained satisfy the first two requirements for obtaining high property brazing, i.e. the brazing temperature is lower than the β-transus, and the joints thus fabricated have sufficiently high mechanical strength. However, unfortunately, the obtained brazing joints still have lower corrosion resistance than the base metal and may retain a tendency to form galvanic couples in which brazing joints play the part of anodes.

The third requirement for quality brazes, high corrosion resistance without the tendency of forming galvanic couples in which the brazing is anodic (has more negative potential) with respect to the base metal, can be achieved when the potential of the braze in the given aggressive medium is equal or more positive than the potential of the base metal.

It is known [U.S. Ruscol Handbook “Constructional Ti Alloys in Chemical Industry”. Moscow, Ed. Chimia, pp 138-145, 1989 (in Russian)] that titanium based alloys containing several tenths of a percentage of palladium or of other platinum group metals (Pt, Ru, Rh, Ir, Os) possess significantly higher corrosion resistance against pitting and crevice corrosion than unalloyed titanium, particularly in chloride containing environments. The mechanism by which these additions achieve the protective effect is sometimes referred to as ‘cathodic addition’ due to their ability to facilitate the cathodic process of hydrogen ion reduction on their surface. On exposure to the aggressive solution, a small quantity of titanium alloy containing the cathodic addition passes into the solution, leading to metal surface enrichment by the platinum group noble metal. As a result of the relatively high noble metal content on the alloy surface and of the low over-voltage of the hydrogen reducing cathodic process, the alloy potential shifts to the positive side where the titanium assumes a passive state. Based on the properties of these cathodic additions, Titanium Grade 7, a well-known commercial alloy containing 0.12-0.25% of Pd was developed. Although Titanium Grade 7 is characterized by a significantly improved corrosion resistance, it will be appreciated that titanium alloying by a precious metal of the platinum group increases the cost of the titanium alloy significantly. Indeed, even a low concentration of about 0.2% of platinum group metal approximately doubles the cost of the material. Consequently, in order to minimize usage of these noble metals, instead of their use as a bulk material, thin coatings of the noble metals and their alloys are sometimes applied on the surface of titanium components, especially in regions where crevice development is possible [N. D. Tomashov, “Titanium and corrosion resistant alloys on the base of titanium”. Moscow, Ed. Metallurguia, p.p. 65-69, 1985]. However, this surface engineering solution also requires the use of rather large quantities of precious metal for these coatings. Moreover, the obtained protective layers usually possess low resistance to abrasion, and cannot withstand intensive fluid flow.

It has been reported [O. I. Steklov and L. N. Lapshin, “Corrosion-Mechanical Stability of Brazed Joints”, Moscow, Ed. Mashinostroenie, p.p. 47-48 (1981)] that a Ti-30 atomic percent Pd eutectic alloy has been proposed as a brazing material for titanium. The eutectic possesses high corrosion resistance in 3% and even 5% HCl solutions at temperatures of up to 90° C. However, the brazing temperature of this eutectic is about 1160° C., which is much higher than the α→β phase transition. Consequently, it will be appreciate that this eutectic is not suitable for use as a brazing filler for titanium. Moreover, as the Pd content in this eutectic is very high, the material too expensive for most applications, including the fabrication of corrugated plate heat exchangers, for example.

Palladium containing Ag-based fillers with melting temperatures below 900° C. are commercially available from Wesgo Metals as Gapasil-9, and from the Johnson Matthey Metal Joining Company as Pallabraze 810, Pallabraze 840, Pallabraze 850 and Pallabraze 880. However, there are disadvantages of the silver-based fillers as detailed above.

Thus, fillers suggested in the prior art that may be used for brazing at a temperature lower than 890° C., as required for brazing titanium and its alloys have low mechanical strength, low working temperature, and/or are very expensive, and/or have reduced corrosion resistance with respect to the brazed base metal.

There is a need for titanium brazing filler compositions that increase the corrosion resistance of titanium brazing joints, at least to the level of corrosion resistance of the brazed metal.

There is a particular need for a titanium brazing filler composition that increases the corrosion resistance of titanium brazing joints, at least to the level of corrosion resistance of the metal being brazed, thereby ensuring that the mechanical strength of the brazing joints with increased corrosion resistance will be at least close to the strength of the base metal.

### SUMMARY OF THE INVENTION

There is a long-felt need for titanium brazing filler compositions that increase the corrosion resistance of titanium brazing joints, at least, to the level of corrosion resistance of the base metal and which keeps the brazing temperature of the titanium brazing filler below the α→β phase transition temperature of Titanium, i.e. below 890° C.

There is a long-felt need for titanium brazing filler composition that increases the corrosion resistance of titanium brazing joints, at least, to the level of corrosion resistance of the base metal.

There is a specific need for a brazing method, which may be used for brazing corrugated plates of plate heat exchangers and the like and which results in the formation of a surface protective layer that contains additions of at least one element of the platinum group noble metals, such as palladium, on the brazed metal, such that both the resulting brazed base titanium and the brazing joints possess increased corrosion resistance.

A first aspect is directed to a composition comprising titanium, a small amount of at least one of the platinum group metals and alloying elements that lower the melting point of the composition to below the titanium beta transus temperature.

The platinum group metals are selected from the group consisting of Pt, Pd, Ru, Rh, Ir, and Os.

Typically, the amount of platinum group metal in the composition is about 0.2% by weight.

Optionally, the melting point lowering alloying elements comprise at least one of Cu and Ni.

Preferably the composition further comprises zirconium.

Preferably the composition further comprises a powder consisting of Ti, Zr, Cu and Ni.

In one embodiment, the composition comprises a mixture of Titanium and at least one of the platinum group metals, and additional metals for lowering the melting point.

In one embodiment, the composition comprises a mixture of a first material comprising Ti, Zr, Cu and Ni, and a second material comprising a platinum group metal.

Preferably, the first material comprises Ti, Zr, Cu and Ni in the ratio of 37.5% Ti-37.5% Zr-15% Cu-10% Ni by weight percentage.

In another embodiment the first material comprises titanium, additions for lowering titanium melting point.

Optionally, the second material comprises additional metals that lower the melting point to a value which lies below the beta-transus temperature of titanium.

Preferably the platinum group metal is palladium.

A specific composition comprises a blend of a first formulation consisting of Ti—Zr—Cu—Ni mixed together with a second formulation comprising platinum group metal, preferably palladium.

A more specific composition comprises a blend of a first formulation consisting of 37.5% Ti-37.5% Zr-15% Cu-10% Ni weight percentage mixed together with a second formulation consisting of at least one of the group consisting of Pallabraze 810, Pallabraze 840, Pallabraze 850, Pallabraze 880, Pallabraze 900, as detailed below, or a composition of 47% Pd-47% Ni-6% Si by weight and additional components for reducing the melting point of the second formulation to a temperature which is lower than about 900 C (the β-transus temperature of Titanium).

| Melting | Composition, % w. | | | | | | |
|---|---|---|---|---|---|---|---|
| point ° C. | Si | Ga | Ni | Cu | Ag | Pd | Pallabraze No |
| 807-810 | | | | 26.5 | 68.5 | 5 | Pallabraze 810 |
| 834-840 | | | | 22.5 | 67.5 | 10 | Pallabraze 840 |
| 824-850 | | | | 31.5 | 58.5 | 10 | Pallabraze 850 |
| 810-851 | 6.1 | | 47.2 | | | 46.7 | Pallabraze 851 |
| 856-880 | | | | 20 | 65 | 15 | Pallabraze 880 |
| 845-880 | | 9 | | | 82 | 9 | Pallabraze 880Ga |
| 876-900 | | | | 28 | 52 | 20 | Pallabraze 900 |

Any of these Pallabraze formulations, as well as other compositions containing metals of platinum group and melting point less than beta-transus temperature of titanium can be used as a second composition.

For example, a specific composition comprises a blend of a first (basic) formulation #1, consisting of Ti-37.5Zr-15Cu-10Ni (weight percentage) mixed together with a second formulation (Pallabraze 880Ga) consisting of Ag-9% Pd-9% Ga (weight percentage).

Preferably the composition comprises between about 0.1 and about 0.8% weight percent of Palladium.

Most preferably the composition comprises between 0.2% weight and 0.3% weight of Palladium.

In one embodiment, the composition is a blend of powders having particle size in the range of from 45 μm to 120 μm (+325 mesh).

For example, the composition may comprise a mixture of a first formulation powder comprising a titanium alloy having a melting point in the range of 850° C.-880° C., and a second powder formulation having a melting temperature below 880° C. that comprises a platinum group metal.

An aspect of the invention is directed to a composition comprising a transition metal such as copper or nickel, and further comprising up to 0.5% of a platinum group metal.

Preferably, the platinum group metal is palladium.

The composition may be used as a filler for brazing titanium.

It will be noted that titanium and titanium alloy components brazed together by the filler demonstrate very good corrosion resistance despite having only minimal noble metal content.

In addition to being useful as a filler, the composition may be used as a coating for coating a surface of titanium.

A further aspect is directed to a method of brazing components fabricated from the group consisting of titanium and titanium alloys, comprising spraying of at least one layer of an organic binder onto selected areas of the components and spraying onto the organic binders powdered fillers comprising compositions of titanium, at least one platinum group metal, and other metals for reducing the melting point of the platinum group metal, containing composition and the mixture to a temperature which is lower than the Ti beta-transus, and heating said sprayed layers to a temperature at which it melts.

Optionally, the other metals are selected from the group consisting of zirconium and transition metals.

Typically the platinum group metal comprises palladium.

A further aspect is directed to a method of brazing components fabricated from the group consisting of titanium and titanium alloys, comprising spraying an organic binder onto selected areas of the components and spraying onto the organic binder a powdered filler comprising a blend comprising a first composition of titanium, zirconium and transition metals, and a second composition comprising a platinum group metal and components for reducing the melting point of the second composition to a temperature of between 850° C. and 880° C. and heating the powdered filler to a temperature of between 850° C. and 880° C.

In one embodiment, the composition is sprayed onto the organic binder over an entire surface of the brazed components.

In another embodiment, the composition is sprayed only at points to be brazed.

The method may be used for brazing corrugated plates of a plate heat exchanger, wherein said components are plates of the heat exchanger.

The heating is performed under vacuum. Typically, the vacuum has a pressure of less than 2×10⁻⁶ Torr.

One of the advantages of the coating or brazing described is that a thin layer of coating or brazing as thin as 10 μm gives a good protection against corrosion. Although coatings with very small amounts of platinum group metal have been found to display good corrosion resistance, it will be appreciated that coatings and brazings with larger proportions of platinum group metal, such as, say, 10% palladium or more, will be expected to give at least as good corrosion resistance. Since the overall coating thickness is minimal, the material cost is not excessive.

### BRIEF DESCRIPTION OF THE FIGURES

For a better understanding of the invention and to show how it may be carried into effect, reference will now be made, purely by way of example, to the accompanying drawings which are optical micrographs of brazes, specifically:

FIG. 1 is an optical micrograph of a section through two titanium plates brazed by filler #1 only, and subject to the corrosion test of Example 1.

FIG. 2 is an optical micrograph of a section through two titanium plates brazed by filler #1 with the addition of 0.2% of Pd introduced into the filler in the form of Pallabraze 880Ga (#2), and

FIG. 3 is an optical micrograph of a section through two titanium plates brazed by filler #1 with the addition of 0.2% palladium powder, and subsequently exposed to a tough corrosive regime.

### DESCRIPTION OF EMBODIMENTS

Embodiments of the present invention relate to a composition for brazing titanium and its alloys, and for surface engineering of titanium and its alloys. The coatings and brazes have notably high corrosion resistance.

In one embodiment, the composition comprises a mixture of Ti, and at least one platinum group metal, and additional metals for lowering the melting point of the mixture to a value which lies below the beta-transus temperature of titanium.

Preferably, the composition has a melting point in the range of 850° C. to 880° C.

A novel composition was made by blending a titanium based filler with a second filler that included small quantities of a platinum group metal. The first powder used in the blend included titanium, the transition metals copper and nickel, and also zirconium.

Specifically, a blend of Ti-37.5Zr-15Cu-10Ni (% weight) was used. This blend, known as TiBr-375, is referred to herein below as Filler #1, which is a Ti-based filler that is available as a vacuum atomized pre-alloyed powder (+325 mesh, 45-120 μm) from Titanium Brazing INC. Filler #1 has a melting point Tₘ of about 845-850° C. and was used in the examples described below as a reference brazing filler.

A particular embodiment is directed to a filler composition that consists of the reference filler #1 with the addition of a second filler, henceforth filler #2, containing a platinum group noble metal, preferably palladium, together with other metals to reduce the melting point of the second filler to a temperature below 880° C. The weight ratio of fillers #1/#2 in the resulting final filler composition is such that the content of platinum group metal in the final filler lies in the range 0.1-0.5%, and is preferably in the range of about 0.2-0.3% by weight.

A further embodiment is directed to the addition of 0.1-0.5% wt % of platinum group metal, such as palladium in a powder form to Ti—Zr—Cu—Ni filler (filler #1) by mechanical blending to create a composition that may be used for brazing.

Thus one aspect of the present invention is directed to a composition for titanium brazing that has a melting point below the α→β phase transition temperature of Ti, and which includes the addition of a noble metal of the platinum group to the composition, and a method of titanium brazing with this filler composition.

A further aspect relates to a method of spot brazing components fabricated from titanium and its alloys. In one application, the components are corrugated plates of titanium PHE, with the filler composition for the brazing including a platinum group metal. The filler may be applied uniformly on a part of or on the whole corrugated plate surface by a cold spray technique using an organic binder, such as 650 Nicrobraz Cement, for example. In the brazing process, after the filler metal melts and wets the components to be joined, the brazed parts of titanium or its alloy are retained at a temperature of 880° C.-890° C. for about 10 to about 30 minutes.

Filler #1, having a preferable composition of 37.5% Ti-37.5% Zr-15% Cu-10% Ni and sold by Titanium Brazing INC as TiBr-375, is a commercially available vacuum atomized pre-alloyed powder (+325 mesh, 45-120 μm). Filler 1#, has a melting point Tₘ of about 845-850° C. and was used as a basic brazing filler. It may be noted, however, that other pre-alloyed titanium brazing compositions, such as other Ti—Zr—Cu—Ni compositions of Titanium Brazing INC may be used instead of 37.5% Ti-37.5% Zr-15% Cu-10% Ni as the basic filler #1.

The mechanical strength of brazing joints fabricated using filler #1 is close to or even sometimes higher than the strength of the brazed Ti.

Filler #2 containing Pd as a platinum group metal and having a melting point below 880° C. is added to filler #1. Fillers #1 and #2 are mixed in a mixer, in a weight ratio which lies in the range from 95/5 to 98/2.

The weight ratio of fillers #1/#2 is calculated so that in the resulting filler composition, the palladium content lies in the range of 0.2-0.5 wt %. Consequently, the content of filler #2 in filler #1 is low. For example, in order to obtain a brazing powder with a palladium (Pd) content of 0.2% in the filler, commercially available Gapasil-9 (Ag-9% Pd-9% Ga)+325 mesh was used as a second filler (filler #2). The weight ratio filler #1/filler #2 was 97.8/2.2. It is noted that the filler included only a small quantity of filler #2 which itself contains only small amounts of Pd, nevertheless, the addition of this small amount of Pd to the filler was found to increase the corrosion resistance of the brazing joint, despite the fact that it did not noticeably affect the microstructure and mechanical properties of the base filler #1.

The weight ratio of filler #1/filler #2 lies in the range from 95/5 to 98/2. The content of Pd in the filler is in the range 0.45-0.18%.

Silver (Ag), which is one of components of filler #2, is a noble, thermodynamically stable metal and its addition cannot lead to the corrosion resistance reducing and to potential shift of the brazing to the negative side. Its content in the resulting filler blend of #1 and #2 is relatively small—in the range 4.6%-1.82%.

Ga, the other component of filler #2, has similar properties to Al. It was found that small amounts of Ga, of a similar order to the Pd content, does not influence significantly the corrosion and electrochemical characteristics of the brazing.

In an alternative embodiment, 0.1-0.8% of a platinum group metal is directly introduced into the filler #1 in the form of powder prior to the brazing operation. It was found that the platinum group metals dissolve regularly in the filler #1 during the brazing process.

The resultant blended filler is applied by cold spaying onto a surface to be brazed over a layer of previously sprayed organic binder. As corrugated plates of a plate heat exchanger are brazed, one or both of the adjacent plates to be brazed together are coated before the brazing operation with a uniform layer of a determined thickness of the brazing filler.

To prevent contamination, specifically oxidation or reduction with oxygen and carbon dioxide in the air, the brazing may be carried out in a vacuum furnace at a temperature of about 880° C. for 10-30 minutes, the exact time depending on thickness and other parameters, where the vacuum was about 2×10⁻⁶ Torr.

Where components fabricated from Ti or its alloys have to be brazed in specific regions, as opposed to all over brazing, the specific parts of the components are coated with the brazing filler using cold spraying, for example. The amount of the sprayed filler applied may be controlled by weighing.

Owing to the presence of the platinum group metal, such as Pd, the obtained brazing joints have a more positive potential than the potential of brazed Ti or of its alloys. Consequently, the joints are not anodic with respect to the base metal and, therefore, do not undergo galvanic corrosion. As a result of this, brazing joints containing a platinum group metal not only themselves possess elevated corrosion resistance, but in some conditions may increase the corrosion resistance of the brazed parts of Ti which are in electric contact with these joints. This state of affairs may occur in instances where the surface area of the brazing joints containing platinum group metal that is exposed to the aggressive environment is significant with respect to the surface area of the base titanium.

It has been found that the amount of platinum group metal in the brazing joint is close to the platinum group metal content in the filler as applied to the brazing area before the brazing operation. In preferred embodiments, the lower limit of the Pd content in the brazing joint lies within the limits of Pd content in Titanium Grade 7, i.e. between 0.12% and 0.25%. Typically, the lower limit is about 0.2%. It was found that in spite of this very low Pd content, such brazing joints, like the alloy Titanium Grade 7, have significantly increased corrosion resistance with respect to unalloyed titanium.

It will be appreciated that when two metallic parts are joined by brazing in one or in several areas, only the surface areas of metal that are to be brazed are coated by the brazing filler. After the brazing operation, the filler is disposed between these parts. Only a small share of filler goes out of the joined parts. It has been found that in a given corrosion environment, different corrosion potential values between the joint and the base metal small surface area of the external joint do not exert a noticeable galvanic effect on the base metal. However, at the same time, the base metal exerts a strong galvanic effect on the brazing joint which has a small surface area with respect to the surface area of the base metal component. Consequently, when the joint has a more negative corrosion potential than the base metal, it may undergo intensive corrosion attack, but when the joint potential has a higher potential than the base metal, particularly, when a metal of platinum group is added to the brazing filler, the brazed joint has been found to be more corrosion resistant and does not influence the corrosion stability of the base metal.

When brazing is carried out in a great number of points of contact of two or more metallic parts, the filler distribution is quite different.

A promising application for brazing is the joining together of the corrugated plates of plate heat exchangers. When two or more adjacent corrugated plates are brazed together, they have a great number of contact points, and in this case the whole surface of one or of both adjacent brazing plates are coated by the filler, as described above.

In the brazing process, after the filler melts, most of the filler around the points of contact shrinks towards these points. This occurs due to the surface tension of the liquid filler layer. A share of the filler that reacts with the titanium surface remains on the base metal surface and forms a remaining layer. When the filler contains the addition of a platinum group metal, such as palladium, the remaining layer includes the platinum group metal. This remaining layer has the properties of a titanium alloy containing a platinum group metal. As discussed above, similar alloys, such as Titanium Grade 7 (Ti with 0.12-0.25% Pd), possesses significantly increased corrosion resistance with respect to unalloyed titanium. The thickness and composition of the remaining layer depends on various parameters such as the temperature and the time that the titanium is in contact with the melted layer, on the titanium surface state, on the thickness and composition of the filler layer that was placed at the area of the point of contact before brazing, and the like. Usually the thickness of the remaining layer is in the range of about 5-30 microns.

Although, as noted above, the platinum group metal content in the brazed points is close to the platinum group metal content in the brazing filler, after the brazing the content of this metal in the rest of the layer is lower, since titanium diffuses into the coating. Usually the platinum group metal concentration within the surrounding layer remains more than half of the content of platinum group metal in the brazing filler. For example, when the content of Pd in the filler is in the range 0.25-0.4%, its content in the remaining layer was found to be in the range 0.15-0.3%. It will be noted that this content is rather close to Pd content in Titanium Grade 7. Therefore, corrosion resistance of the surrounding layer is significantly higher than the corrosion resistance of unalloyed corrugated titanium plate. At the same time, the corrosion resistance of the brazing joint is generally not lower than that of the surrounding surface layer, since the brazing joint contains less dissolved titanium and, consequently, a higher content of platinum group metal than that of the remaining layer. Like the brazed point of contact, the remaining layer provides corrosion protection of the unprotected surface of the corrugated plate. The larger the surface area of the remaining layer, the more effective is its protective action.

According to the most preferable embodiment of the present invention, the whole surface of the corrugated plate brazed to the adjacent plate is coated by the filler. In this embodiment, the remaining layer is formed on the whole surface of the brazed corrugated plate and provides maximal corrosion protection. Thus, introduction of platinum group metal into the filler for brazing titanium plate heat exchanger significantly increases the corrosion resistance of both the brazing joints and Ti base metal.

The remaining layer composition results from the filler composition, and from its dissolution in the base metal and from reactions with the filler components. Consequently, along with increased corrosion resistance, the remaining layer is characterized by good adhesion to the base metal and a higher hardness which generally results in enhanced wear resistance.

In a further embodiment, a blend of powders #1 and #2 are sprayed onto an organic binder that is deposited on the titanium surface, possibly by spraying. The titanium surface is then heated to a temperature of between about 880° C. and about 890° C. for about 10 to 30 minutes. This treatment is similar to that carried out in the brazing operation, but is not used to join two components. Rather, the composition is used as a coating which enhances the corrosion resistance of the surface and is equal to the corrosion resistance of alloy Ti-0.2% Pd (Titanium Grade 7). Thus, this composition is used in the considered option as coating material.

In accordance with a further embodiment, introduction of the platinum group metal into the filler #1 (37.5% Ti-37.5% Zr-15% Cu-10% Ni) may also be achieved by its direct addition to the brazing filler before it is sprayed onto the metal surface to be brazed. The added quantity of the platinum group metal is in the range from 0.1 to 0.5% by weight, and preferably in the range of from 0.2 to 0.3% with respect to the brazing filler. In this application, the method of the filler spraying on the surface is the same as in the case discussed hereinabove, and the remaining layer that forms on the plate surface after the brazing operation has a composition, thickness and protective properties similar to the ones obtained in the previous case, in which the filler is formed by mixing two fillers, #1 and #2.

Thus, a method of brazing components fabricated from the group consisting of titanium and titanium alloys, such as heat exchange plates, for example, consists of the steps of (a) spraying an organic binder onto the surface of the titanium components (b) spraying a powdered filler composition comprising a basic composition (titanium, zirconium, nickel and copper), and further comprising 0.2% to 0.3% of a platinum group metal, preferably Pd (together with additional metals lowering melting point of the platinum group metal) onto the previously sprayed organic binder, and (c) heating to a temperature of between 850° C. and 880° C.

A further aspect is directed to a method of brazing components fabricated from the group consisting of titanium and titanium alloys, comprising spraying at least one layer of an organic binder onto selected areas of the components and spraying onto the organic binders powdered fillers comprising a blend of a first composition consisting of titanium and other materials such as zirconium and transition metals such as copper and nickel, and a second composition consisting of a platinum group metal such as Pd and other elements for reducing the melting point of the second composition, and then heating the components to a temperature which is above the melting point of the blend, but is lower than the Ti beta-transus.

### EXAMPLES

### Example 1

Three specimens of Ti grade 2 were prepared for subsequent corrosion testing by brazing two corrugated plates to one another with a filler composition consisting of two fillers: filer #1 (37.5% Ti-37.5% Zr-15% Cu-10% Ni) and filler #2 (78% Ag-9% Pd-9% Ga), which is commercially available as Pallabraze 880Ga. The filler composition consisted of the two fillers in the ratio #1/#2 of 97.8/2.2; such that the resultant filler contained 0.2% of Pd.

The content of Pd in the resultant brazing joints was found to be 0.2%. The Pd was regularly distributed in the joint. Three specimens of Ti Grade 2 brazed by filler #1 without any additions such as palladium were prepared for comparative corrosion testing.

Corrosion testing was carried out by immersion of the specimens in a 40% solution of LiCl at temperature 120-135° C. and pH 3 over a period of 320 hours (15 days); the pH was reduced by addition of HCl to the solution.

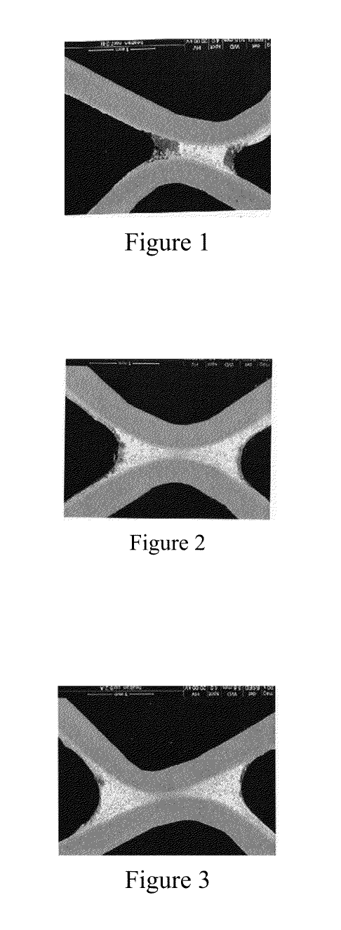

With reference to FIG. 1, pitting were discerned on the brazing carried out by filler #1 and local corrosion damages were found at the edges of Ti corrugated plates, as shown in metallographic cross-sections through the joints. About ⅓ of the joint was destroyed.

With reference to FIG. 2, in a similar braze of titanium plates using the filler #1 with the addition of Pallabraze 880Ga (Ag-9% Pd-9% Ga) known herein as filler #2 to provide a concentration of 0.2% palladium in the composition, only traces of corrosion damage were found.

### Example 2

Three specimens of Ti grade 2 were prepared for corrosion test by brazing together two corrugated plates with a filler on the base of filler #1 (37.5% Ti-37.5% Zr-15% Cu-10% Ni) with the addition of 0.2% Pd powder. Testing of these specimens was carried out in a 40% solution of LiCl, under condition described hereinabove with reference to Example 1.

With reference to the photomicrograph of FIG. 3, only very slight signs of corrosion damage were found at the brazing that contained 0.2% of Pd that was introduced into the filler by dissolution Pd powder in the base filler #1.

### Example 3

Three specimens of Ti Grade 2 were prepared for corrosion test by brazing together two corrugated plates using a filler consisting of a mixture of two fillers #1 and #2. The Pd content in the filler was 0.3%. The filler composition and brazing procedure are as described hereinabove with reference to Example 1.

Three other specimens of Ti Grade 2 brazed by filler #1 without any further additions were prepared for comparative corrosion test.

The testing of these specimens was carried out in a 32-35% solution of MgCl₂ at temperature 120° C. and pH 3; the pH being reduced by addition of HCL to the solution.

The following table summarizes the test conditions.

| Duration | | | Solution | |
|---|---|---|---|---|
| (hours) | Temp (° C.) | pH | Concentration, % | Stages |
| 99 | 118 | ~3 | 31.9 | 1 |
| 99 | 12 | 3.5~ | 35.1 | 2 |
| 102 | 130 | 3.5~ | 35.3 | 3 |
| 98 | 135-150 | 3.5~ | Above 35.3 | 4 |

The total test duration was 398 hours.

The results have shown that the brazing joints that did not contain Pd underwent significant corrosion damage, with about 50% of the joint being attacked. Local corrosion damages were also noted in areas of the Ti base metal.

However, the brazing joints obtained using commercial filler #1 with the addition of a 0.2% powder of Pd by a mixture of the two fillers, #1 and #2 in the ratio 97.8/2.2 showed a maximum depth of corrosion penetration that was less than 100 μm as revealed in metallographic cross-sections.

### Example 4

Three specimens of Ti grade 2 were prepared for the corrosion test by brazing two corrugated plates together using a filler consisting of filler #1 (37.5Ti-37.5Zr-15Cu-10Ni) with the addition of 0.2% of Pd powder, as described hereinabove with reference to Example 2.

The specimens were corrosion tested in solutions of MgCl₂, under the conditions described above with respect to Example 3.

As with Example 3, the maximum depth of corrosion penetration into the brazing joints obtained on the base of filler #1 with addition of 0.2% powder of Pd was less than 100 μm.

Thus, Examples 1-4 show that in concentrated and acidified solutions of LiCl and MgCl₂ at elevated temperatures, brazing joints containing addition of Pd displayed much higher corrosion resistance than base brazing joints without the addition of Pd.

### Example 5

Two corrugated plates of Ti grade 2 were brazed together using a filler consisting of two fillers: #1 (37.5Ti-37.5Zr-15Cu-10Ni) and #2 (81% Ag-9% Pd-9% Ga) at weight ratio #1/#2 of 97.8/2.2, as described in Example 1, such that the resulting filler contained 0.2% of Pd. The brazed specimens were then prepared for corrosion-electrochemical testing.

A similar specimen of Ti grade 2 corrugated heat exchanger plates were brazed by mixture #1 without any further additions, was prepared for a comparative test.

The procedure for preparation of the specimens for brazing was as follows:

The whole surface of one of each pair of corrugated plates was coated by the above mentioned mixture prior to brazing.

After the brazing operation, the thickness of the remaining layer on the surface of the base metal was about 30 microns.

The brazed specimens were protected on 3 sides by an epoxy resin and 5% HCl solution was introduced through the open fourth side into the space between the corrugated plates, holding the solution temperature at 28° C. The potential of the brazed titanium plates exposed to the 5% HCl solution was measured over a 24 hour period using a Ag/AgCl reference electrode immersed in saturated KCl (potential 197 mV with respect to Normal Hydrogen Electrode). A Luggin capillary probe was introduced into the space between the brazed plates to measure the local potentials there.

During the test, the metal potential shifted to the positive side, from −250 mV to 100 mV (against saturated Ag/AgCl electrode). The potential value of titanium above −250 mV indicates the passive state of the metal. The solution after the test remains transparent and uncoloured, which shows that the metal remained in a passive state and did not undergo corrosion attack.

The potential of the specimen brazed by filler #1 which did not contain Pd changed in the range −310 mV to −420 mV which relates to an active state of the metal. The solution after the test has a violet color which indicates the presence of Ti³⁺ ions and demonstrates active titanium dissolution in the conditions considered.

### Example 6

Specimens of Ti Grade 2 were brazed together using a filler of the composition #1 (37.5Ti-37.5Zr-15Cu-10Ni) with the addition of 0.2% Pd powder, as described in Example 2, hereinabove, and prepared for -electrochemical corrosion testing.

The procedure for preparation of the specimens for brazing was as follows:

The whole surface of one of each pair of corrugated plates was coated before brazing by the above mentioned filler mixture. After brazing, the remaining layer on the surface of the base metal had a thickness of tens of microns.

The brazed specimens were protected on three sides using epoxy resin. A 5% HCl solution was introduced through the open fourth side into the space between the corrugated plates. The galvanic potential of the brazed titanium plates was measured over 24 hours with the help of a Ag/AgCl reference electrode immersed in saturated KCl (potential 197 mV with respect to Normal Hydrogen Electrode). The solution temperature was 28° C. A Luggin capillary probe was introduced for measuring potentials within the space between the brazed plates.

During the test the metal potential shifted to the positive side, from −250 mV to −150 mV (against saturated Ag/AgCl electrode). This shows that the metal remains in its passive state in the considered conditions. The solution after the test remains transparent and uncolored, which shows that the metal was in a passive state and did not undergo corrosion attack.

Although blended powders were used, the braze filler or coating may be fabricated from amorphous metal ribbon, which is another way of obtaining mixtures of elements that do not alloy in a traditional manner.

The present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

We claim:

1. A composition comprising: titanium, a small amount of at least one platinum group metal and alloying elements for lowering melting point of the composition to below titanium beta transus temperature.

2. A composition comprising: titanium, a small amount of at least one platinum group metal and alloying elements for lowering melting point of the composition to below 900° C.

3. The composition of claim 1, wherein the platinum group metal is selected from the group consisting of Pt, Pd, Ru, Rh, Ir, and Os.

4. The composition of claim 1, wherein the platinum group metal is paladium.

5. The composition of claim 1, wherein the amount of platinum group metal in the composition is at least 0.1% by weight.

6. The composition of claim 1, wherein the amount of platinum group metal in the composition is about 0.2% by weight.

7. The composition of claim 1, wherein the alloying elements for lowering melting point of the composition comprise at least one of Cu and Ni.

8. The composition of claim 7, further comprising zirconium.

9. The composition of claim 1, comprising a mixture of a first powder comprising Ti, Zr, Cu and Ni, and a second powder comprising a platinum group metal.

10. The composition of claim 9, wherein the second powder comprises palladium.

11. The composition of claim 9, wherein the first powder comprises Ti, Zr, Cu and Ni in the weight ratio of 37.5Ti:37.5Zr:15Cu:10Ni.

12. The composition of claim 9, wherein the second powder comprises additional metals that lower the melting point to a value below 900 C.

13. The composition of claim 9, wherein the second powder comprises a formulation selected from the group consisting of Pallabraze 810, Pallabraze 840, Pallabraze 850, Pallabraze 851, Pallabraze 880, Pallabraze 880Ga, Pallabraze 900, and 47% Pd-47% Ni-6% Si by weight.

14. The composition of claim 9, wherein the second powder comprises a formulation selected from the group consisting of additional components for reducing the melting point of the second formulation to a temperature which is lower than about 900° C.

15. The composition of claim 9, wherein the second powder comprises 72% Ag-9% Pd-9% Ga by weight.

16. The composition of claim 9, comprising between about 0.1% and about 0.8% weight percent of Palladium.

17. The composition of claim 9, comprising between 0.2% weight and 0.3% weight of Palladium.

18. The composition of claim 1, comprising a blend of powders having particle size in the range of from 45 to 120 μm (+325 mesh).

19. The composition of claim 9, comprising a mixture of a first powder comprising a titanium alloy having a melting point in the range of 850° C.-880° C., and a second powder having a melting temperature below 880° C. that comprises a platinum group metal.

20. A filler for brazing titanium, comprising the composition of claim 1.

21. A coating for coating a titanium surface, comprising the composition of claim 1.

22. A composition comprising: titanium, a transition metal and up to 0.5% of a platinum group metal.

23. The composition of claim 22, wherein the platinum group metal is palladium.

24. The composition of claim 22, wherein the transition metal comprises at least one of the group consisting of copper and zinc.

25. A filler for brazing titanium, comprising the composition of claim 22.

26. A coating for coating a titanium surface, comprising the composition of claim 22.

27. A method of brazing components fabricated from a material selected from the group consisting of: titanium and titanium alloys, the method comprising spraying of at least one layer of an organic binder onto selected areas of the components and spraying onto the organic binders powdered fillers comprising compositions of titanium, at least one platinum group metal, and other metals for reducing the melting point of the mixture to a temperature which is lower than the Ti beta-transus of the material, and heating said sprayed layers to a temperature at which it melts.

28. The method of claim 27, wherein the other metals are selected from the group consisting of: zirconium and transition metals.

29. The method of claim 27, wherein the platinum group metal comprises palladium.

30. A method of brazing components fabricated from the group consisting of: titanium and titanium alloys, the method comprising spraying an organic binder onto selected areas of the components and spraying onto the organic binder a powdered filler comprising a blend comprising a first composition of titanium, zirconium and transition metals, and a second composition comprising a platinum group metal and components for reducing the melting point of the second composition to a temperature of between 850° C. and 880° C. and heating the powdered filler to a temperature of between 850° C. and 880° C.

31. The method of claim 30, wherein the composition is sprayed onto the organic binder over an entire surface of the brazed components.

32. The method of claim 30, wherein the composition is sprayed onto the organic binder at selected points to be brazed.

33. The method of claim 30, wherein the components are corrugated plates of a plate heat exchanger.

34. The method of claim 30, wherein the heating is performed under vacuum.

35. The method of claim 34, wherein the vacuum has a pressure of less than 2×10⁻⁶ torr.

36. A method of surface treating components fabricated from titanium or titanium alloys, comprising spraying an organic binder onto selected areas of the components and spraying onto the organic binder a powdered filler comprising a blend comprising a first composition of titanium, zirconium and transition metals, and a second composition comprising a platinum group metal and components for reducing the melting point of the second composition to a temperature of between 850° C. and 880° C. and heating the powdered filler to a temperature of between 850° C. and 880° C.

37. The method of claim 36 wherein said surface treatment increases corrosion resistance of said areas.
